(19) United States
(12) Patent Application Publication
(10) Pub. No.: US 2007/0073543 A1
(43) Pub. Date: Mar. 29, 2007

(54) Supported method for speech dialogue used to operate vehicle functions

(75) Inventors: Matthias Hammler, Berlin (DE); Florian Hanisch, Esslingen (DE); Steffen Klein, Berlin (DE); Hans-Josef Kuetting, Remseck (DE); Roland Steigler, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/569,057

(22) PCT Filed: Aug. 10, 2004
(86) PCT No.: PCT/EP04/08923

§ 371 Date: Dec. 6, 2006

(30) Foreign Application Priority Data
Aug. 22, 2003 (DE) 103 38 512.6

(51) Int. Cl. G10L 21/00

(52) U.S. Cl. 704/275

(57) ABSTRACT

A support method for speech dialogs for operating motor vehicle functions by means of a speech dialog system for motor vehicles in which a non-speech signal is output in addition to the speech output. Speech dialog systems, which form an interface for communication between man and machine, are disadvantageous when compared with communication between persons because, in addition to the primary information content of the speech dialog, additional information about the state of the other party to the communication, which is conveyed visually in the case of communication between people, is missing. The present invention overcomes this disadvantage in a speech dialog system whereby non-speech signals are output as an auditory signal to the user as a function of the state of the speech dialog system. The method is advantageously suitable for steering motor vehicles and operating their motor vehicle functions since in this way the information content for the driver is increased without at the same time distracting the driver from the events on the road.

### BACKGROUND AND SUMMARY OF THE INVENTION

The invention relates to a support method for speech dialogs for operating motor vehicle which functions by using a speech-activated operator control system for motor vehicles. Non-speech signals are output in addition to the speech output, and a speech-activated operator control system carries out this support method.

A wide variety of speech-activated operator control systems for operating motor vehicle functions by speech control are known. They serve to permit the driver to operate a wide variety of functions in a motor vehicle easily by virtue of the fact that the need to operate pushbutton keys while driving is eliminated and the driver is thus less distracted from the events on the road.

A speech dialog system includes essentially the following components:
1) a speech recognition unit which compares a speech input (“speech command”) with speech commands stored in a speech pattern database, and makes a decision concerning which command was most probably spoken;
2) a speech generating unit which outputs the speech commands and signalling sounds which are necessary for user prompting and, if appropriate, acknowledges the recognized speech command;
3) a dialog and sequencing controller which guides the user through the dialog, in particular in order to check whether the speech input is correct and in order to bring about the action or application which corresponds to a recognized speech command; and,
4) the application unit which constitute the wide variety of hardware and software modules such as, for example, audio devices, video equipment, air-conditioning system, seat adjustment system, telephone, navigation device, mirror adjustment system and/or assistance systems.

Various methods are known for speech recognition. As an example, defined individual words can be stored as commands in a speech pattern database so that a corresponding motor vehicle function can be assigned by comparing patterns.

Phoneme recognition is based on the recognition of individual sounds, what are referred to as phoneme segments being stored for this purpose in a speech pattern database and being compared with feature factors which are derived from the speech signal and contain information on the speech signal which is important for the speech recognition.

A genus-forming method is known from German Patent Document DE 100 08 226 C2 in which the speech outputs are supported by graphic instructions of a nonverbal nature. These graphic instructions are intended to permit the user to take in the information more quickly, and is thus also intended to increase the user's acceptance of such a system. These graphic instructions are output as a function of speech outputs so that, for example, if the speech dialog system expects an input, symbolically waiting hands are represented, a successful input is symbolized by a face with a corresponding expression and clapping hands, or in the case of a warning also by means of a face with a corresponding expression and raised, symbolic hands.

This known method for speech-activated control in which the speech outputs are accompanied by a visual output has the disadvantage that the driver of a motor vehicle can be distracted from the events on the road by this visual output.

The object of the invention is to develop a method whereby the information content which is conveyed to the driver by the speech output is still increased without however distracting the driver from the events on the road in the process. A further object is to specify a speech dialog system for carrying out such a method.

The first-mentioned object is achieved by outputting the non-speech signal as an auditory signal as a function of the state of the speech dialog system. As a result, in addition to the primary information elements of the speech dialog, the speech itself, additional information about the state of the speech dialog system is conveyed. It is thus easier for the user to recognize, by means of the secondary elements of the speech dialog, whether the system is ready for inputting, is currently processing working instructions or has terminated a dialog output. The start of the dialog and the end of the dialog can also be marked with such a non-speech signal. The differentiation between the different motor vehicle functions which can be operated can also be marked with such a non-speech signal, i.e. the function which is called by the user is accompanied by a specific non-speech signal so that the driver of the vehicle recognizes the corresponding subject matter from it. Taking this as a basis, it is possible to build up what are referred to as pro-active messages, i.e. initiative messages which are output automatically by the system are generated so that the user immediately recognizes the nature of the information from the corresponding marker.

Phases of the speech input, of the speech output and times of processing of the speech input are recognized as a state of the speech dialog system. For this purpose, in each case a corresponding time window is generated during which the non-speech auditory signal is output, i.e. reproduced over the auditory channel in synchronism with the corresponding speech-dialog states.

In one particularly advantageous development of the invention, the marking, non-speech auditory signal is output as a function of the motor vehicle functions which can be operated, i.e. a function of the subject matter which is called by the user or the function which is selected by the user. Such structuring of a speech dialog permits, in particular, the use of what are referred to as pro-active messages which are generated automatically by the speech dialog system as initiative messages, that is to say even when the speech dialog is not active. In conjunction with the marking of the specific functions or subject matters it is possible for the user to recognize the nature of the message by reference to the accompanying characteristic signal.

It is also particularly advantageous to indicate to the user the position of a current list element within a displayed list as well as the absolute number of entries on said list by means of a non-speech auditory signal by virtue of the fact that, for example, this information is conveyed by means of corresponding pitches and/or registers. In this way it is possible, for example when navigating within such a list, to playback a combination from acoustic correspondence to the overall number and the correspondence to the location of the actual element.

Characteristic, non-speech auditory outputs in the sense of the invention can be reproduced either as discrete sound events or as variations for continuous basic pattern. Possible variations here are of the timbre or instrumentation, the pitch or register, the volume or dynamics, the speed or the rhythm and/or the sequence of sounds or the melody.

The second-mentioned object is achieved so that, in addition to the function groups which are necessary for a speech dialog system, a sound pattern database is provided in which a wide variety of non-speech signals are stored, which signals are selected and output by a speech characterizing unit as a function of the state of the speech dialog system and/or mixed into a speech signal. As a result, this method can be integrated into a customary speech dialog system without a large degree of additional expenditure on hardware.

The invention will be presented and explained below by means of an exemplary embodiment and in relation to the figures, of which:

### BRIEF DESCRIPTION OF THE DRAWINGS

FIG. 1 is a block circuit diagram of a speech dialog system according to the invention,

FIG. 2 is a block circuit diagram explaining the sequence of a speech dialog, and

FIG. 3 is a flowchart explaining the method according to the invention.

### DETAILED DESCRIPTION OF THE DRAWINGS

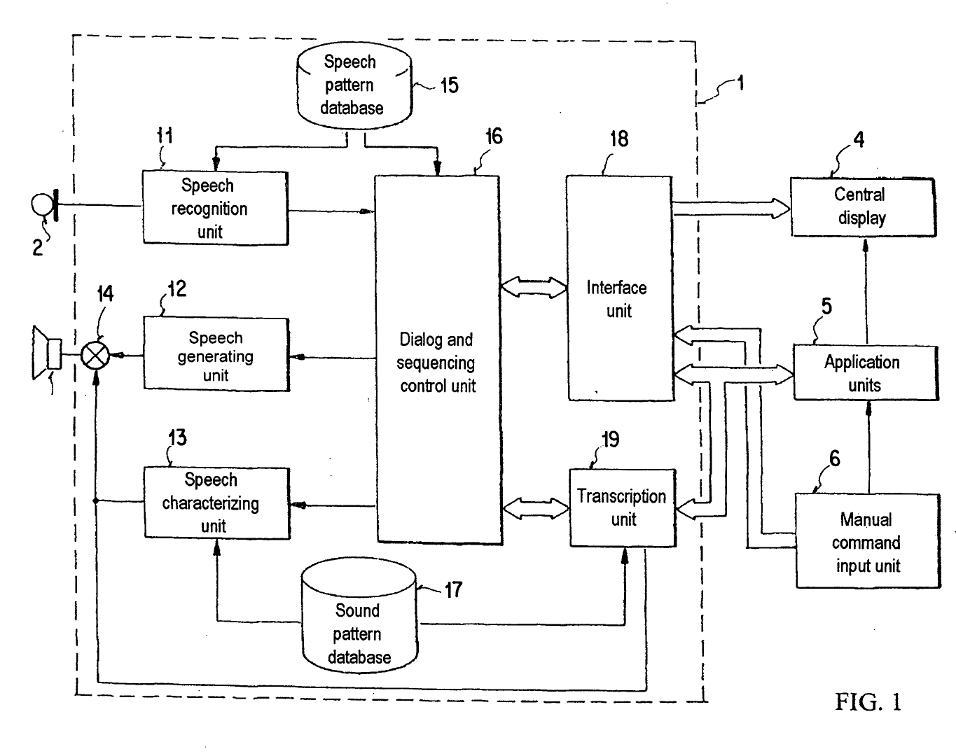

A speech dialog system 1 according to FIG. 1 is supplied, via a microphone 2, with a speech input which is evaluated by a speech recognition unit 11 of the speech dialog system 1. The speech signal is compared with speech patterns stored in a speech pattern database 15, and by a speech command being assigned. A dialog and sequencing control unit 16 of the speech dialog system 1 controls the rest of the speech dialog in accordance with the recognized speech command, or the execution of the function corresponding to this speech command is brought about by the interface unit 18.

This interface unit 18 of the speech dialog system 1 is connected to a central display 4, with application units 5 and a manual command input unit 6. The application units 5 may constitute audio/video devices, an air-conditioning system, a seat adjustment system, a telephone, a navigation system, a mirror adjustment system or an assistance system such as, for example, an inter-vehicle distance warning system, a lane changing assistant, an automatic brake system, a parking aid system, a lane assistant or a stop-and-go assistant.

In accordance with the activated application, the associated operator control and/or state data and/or data on the surroundings of the vehicle is displayed to the driver on the central display 4.

In addition to the acoustic operator control by the microphone 2, as already mentioned, it is also possible for the driver to select and operate a corresponding application by means of the manual command input unit 6.

If, on the other hand, the dialog and sequencing control unit 16 does not detect a valid speech command, the dialog is carried on by a speech output by a spoken speech signal being output acoustically using a loudspeaker 3 by means of a speech generating unit 12 of the speech dialog system 1.

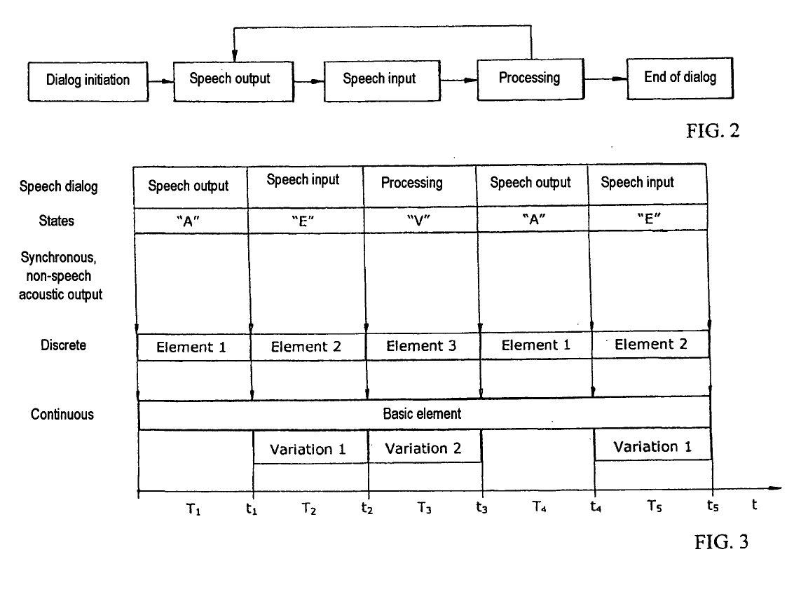

A speech dialog proceeds in the fashion illustrated in FIG. 2, with the entire speech dialog being composed of individual phases which also repeat continuously. The speech dialog starts with a dialog initiation, which can be triggered either manually, for example by means of a switch, or automatically. In addition it is also possible to make the speech dialog start with a speech output on the part of the speech dialog system 1, in which case the corresponding speech signal can be generated synthetically or by a recording. After this speech output phase, there is a following speech input phase whose speech signal is processed in a subsequent processing phase. After this, either the speech dialog is carried on with a speech output on the part of the speech dialog system or the end of the dialog is reached, which is brought about either manually again or automatically by virtue of the fact that, for example, a specific application is called. For the aforesaid phases of a speech dialog, such as the speech output phase, the speech input phase and the processing phase, time windows of a specific length are made available, during only one point in time is marked by the start of the dialog and the end of the dialog. As illustrated in FIG. 2, the speech output, speech input and processing phases can repeat as often as desired.

However, such a speech dialog system has, as an interface for communication between man and machine, certain disadvantages compared to customary communication between persons since additional information about the state of the other party to the communication as well as the primary information elements of the speech dialog are missing and are conveyed visually during a purely human communication. In a speech dialog system, this additional information relates to the state of the system, that is to say, for example, whether the speech dialog system is ready for inputting, whether it is currently in the “speech input” state, or whether it is currently processing working instructions, i.e. it is in the “processing” state, or when a relatively long speech output is terminated, that is it relates to the “speech output” state. In order to characterize or mark these different states of the speech dialog system, non-speech acoustic outputs are output using the auditory channel, that is with the loudspeaker 3, in synchronism with these speech-dialog states.

This non-speech identification of the speech-dialog states of the speech dialog system 1 is illustrated in FIG. 3 in which the first line shows the states of a speech dialog, already described with reference to FIG. 2, during their chronological sequencing. The speech dialog illustrated here starts at the time t=0 and ends at the time t₅ and is composed of the phases of the speech dialog which characterize the speech-activated operator control states, specifically the state A which is determined by the “speech output” phase and which lasts up to the time t₁, the adjoining state E which is characterized by the “speech input” phase and which is terminated at the time t₂, the adjoining state V which is characterized by the “processing” phase and which is terminated at the time t₃, and the repeating, subsequent states A and E, which are each terminated at the time t₄ and t₅. The corresponding time periods T₁ to T₅ for the respective state result from this.

In order to characterize the state A, the speech output is provided with an acoustically accompanying non-speech signal, specifically with a sound element 1, during the associated time period T₁ or T₄. In contrast, a sound element 2 is output during the time period T₂ or T₅ by means of the loudspeaker 3 to the state E during which speech inputs are possible by the user—the microphone is therefore “open”. This differentiates the output from the input for the user, something which is advantageous in particular in the case of outputs of a plurality of sentences during which many users have the tendency to already to want to fill in the short pauses after an uttered sentence with the next input.

Finally, the state V, at which the speech dialog system is in the processing phase, is marked for the user with a sound element 3 so that the user is informed when the system is processing the speech inputs by the user and the user can neither expect a speech output nor make a speech input himself. In very short processing time periods, for example, in the μs region, the marking of the state V can be dispensed with, but in the face of longer time periods it is necessary since otherwise there is the risk of the user assuming that the dialog is ended. According to the third row in FIG. 3, a discrete assignment of the sound pattern elements 1, 2 and 3 is made to the respective states.

However, a continuous sound element can accompany the speech dialog from the time t=0 as far as the termination of the dialog at the time t₅ in the manner of a basic pattern, but this basic element is varied in order to characterize or mark individual states so that, for example, the state E is assigned a variation 1, and the state V a variation 2 which differs therefrom, as is represented in the lines 4 and 5 in FIG. 3.

According to FIG. 1, the marking or characterization of the described different states of the speech dialog system is implemented by a speech characterizing unit 13 which is actuated by the dialog and sequencing control unit 16 by virtue of the fact that this state correspondingly detected by the dialog and sequencing control unit 16 selects the corresponding sound element or basic element with, if appropriate, a specific variation from a sound pattern database 17 and feeds to a mixer 14. In addition to this non-speech signal, mixer 14 is also supplied with the speech signal, which is generated by the speech generating unit 12, is mixed therewith and the speech signal which is accompanied by the non-speech signal is output by means of a loudspeaker 3.

Different sound patterns can be stored in memory 17 as non-speech acoustic signals, in which case the tone or instrumentation, the pitch or the register, the volume or dynamics, the speed or the rhythm or the sequence of sounds or the melody are conceivable as possible variations in a continuous basic element.

In addition, the start of the dialog and the end of the dialog can be marked by a non-speech acoustic signal, for which purpose the speech characterizing unit 13 is also correspondingly actuated by the dialog and sequencing control unit 16 so that only a brief auditory output occurs at the corresponding times.

Finally, the speech dialog system 1 has a transcription unit 19 which is connected at one end to the speech and sequencing control unit 16 and at the other to the interface unit 18 and the application units 5. This transcription unit 19 assigns a specific non-speech signal to the actuated application in accordance with the application, for example a navigation system, for which reason the sound pattern database 17 is connected to this transcription unit 19 in order to supply this selected sound pattern to the mixer 14 in order to add this sound pattern to the corresponding associated speech output. As a result, each application is assigned a specific sound pattern so that the corresponding sound pattern is generated when the application is actuated, either by being called by the operator or by automatic activation. As a result of this, the user immediately recognizes the subject matter from this non-speech output, i.e. the application. In particular, when pro-active messages are output, i.e. messages which are generated by the system even when a speech dialog is not active (initiative messages), the user immediately detects the nature of the message by means of this characteristic sound pattern.

The transcription unit 19 also serves to characterize or mark the position of a current list element as well as the absolute number of entries in a list which is output because dynamically generated lists vary in the number of their entries thus permitting user to estimate the total number as well as the position of the selected element within the list. This information about the length of the list or the position of the list element within this list can be marked by corresponding pitches and/or registers. When the user is navigating within the list, a combination of acoustic correspondence to the overall number and the correspondence to the position of the current element within the list is reproduced.

1-15. (canceled)

16. A support method for speech dialogs for operating motor vehicle using a speech dialog system for motor vehicles, comprising the steps:
Outputting a speech signal;
Outputting an auditory non-speech signal as a function of the state of the speech dialog system.

17. The support method as claimed in claim 16, wherein phases of a speech input and the speech output are detected as a state of the speech dialog system, and wherein each of said phases is assigned a specific, non-speech auditory signal.

18. The support method as claimed in claim 17, further comprising the step of generating a recognition time window as a time period during which speech inputs are possible, wherein the non-speech auditory signal is output during said recognition time window.

19. The support method as claimed in claim 17, further comprising the step of generating a playback time window as a time period during which said speech signal is output, wherein the non-speech auditory signal is output superimposed on the speech output during said playback window.

20. The support method as claimed in claim 17, further comprising the step of outputting the non-speech auditory signal by the speech processing system during the processing time of the speech inputs.

21. The support method as claimed in claim 16 wherein the non-speech auditory signal is output in order to mark a speech dialog from the start of a dialog to the end of the dialog.

22. The support method as claimed in claim 16, wherein the non-speech auditory signal which characterizes an operator control function is output as a function of said operator control function which is specified by a speech command.

23. The support method as claimed in claim 16, wherein the speech dialog system generates an initiative message which is assigned to an operator control function and is output automatically, as a function of at least one of the state of the vehicle and the surroundings of the vehicle, together with the non-speech auditory signal which characterizes the assigned operator control function.

24. The support method as claimed in claim 16, wherein during the selection of an option from a list, which list is output due to a speech command, the individual list items, a non-speech auditory signal is output as a function of at least one of the number of list items and the position of the respective list item on the list.

25. The support method as claimed in claim 24 wherein the non-speech auditory signal is varied as at least one of a sound signal with the pitch and the register corresponding to the number of list items and the position of the respective list item.

26. The support method as claimed in claim 16, further comprising the step of generating a discrete sound signal and outputting as a non-speech auditory signal for each speech operator control system state.

27. The support method as claimed in claim 16, further comprising the step of generating a sound signal which is derived from a continuous basic pattern as a non-speech auditory signal for each speech operator control system state.

28. A speech dialog system for motor vehicles for operating motor vehicle functions, in which, in order to support speech dialogs, a non-speech signal is output in addition to the speech output, comprising:
a speech input device;
a speech recognition unit connected to said speech input device, the speech recognition unit and a speech pattern database for evaluating the speech input;
a dialog and sequencing control unit which, as a function of the evaluation of the speech input, actuates at least one of an application unit for controlling motor vehicle functions, and a speech generating unit;
a speech characterizing unit which, as a function of the speech dialog system state, outputs a non-speech auditory signal which characterizes said system state, said non-speed auditory signal provided by a sound pattern database; and
a mixer receiving an output from a speech generating unit and an output of the speech characterizing unit, said mixer actuating a speech output unit.

29. The speech dialog system as claimed in claim 28, further comprising a transcription unit connected to the dialog and sequencing control unit, a sound pattern database, and an application unit in order to assign a non-speech auditory signal to an activated motor vehicle function.

30. The speech dialog system as claimed in claim 28, further comprising a first application unit connected via an interface unit to the dialog and sequencing control unit, and wherein other application units, a central display and a manual command input unit are also connected to the interface unit in addition to said first application unit.
